(19) United States
(12) Patent Application Publication
(10) Pub. No.: US 2017/0355086 A1
(43) Pub. Date: Dec. 14, 2017

(54) OUTDOOR TOOL WITH MULTIPLE FUNCTIONS

(71) Applicant: MIKE C. LEE, Taipei (TW)

(72) Inventor: MIKE C. LEE, Taipei (TW)

(73) Assignee: DURACRAFT PRODUCTS CO., LTD., TAIPEI (TW)

(21) Appl. No.: 15/182,526

(22) Filed: Jun. 14, 2016

(51) Int. Cl. B26B 11/00; B24D 15/06; F23Q 1/06; G10K 5/00

(52) U.S. Cl. CPC B26B 11/001; B26B 11/006; G10K 5/00; B24D 15/06; F23Q 1/06

(57) ABSTRACT

An outdoor tool with multiple functions may comprise a handle, a spring clip, a blade, a cover and a flint rod. When the blade is in a folded position, it is coupled with the spring clip, and an actuating segment of the spring clip can tightly clamp the blade. Furthermore, when blade is in a deployed position, a mounting piece of the blade is mounted on a mounting hole of the spring clip thereby improving the structural stableness. In addition to cutting objects, the outdoor tool also can be used for whistling, starting a fire, opening a bottle, scraping fish scale, sharpening a knife thereby improving the practicability.

### FIELD OF THE INVENTION

The present invention relates to an outdoor tool with multiple functions, and more particularly to an outdoor tool that can be used for cutting, whistling, starting a fire, opening a bottle, scraping fish scale and sharpening a knife.

### BACKGROUND OF THE INVENTION

Generally, an outdoor tool such as Swiss knife comprises a single blade connected with a handle, and a user can use the blade to remove the branches and vines when climbing the mountain and to cut objects for preparing an outdoor picnic.

However, the conventional outdoor tool has following disadvantages: (i) most of the outdoor tools only have cutting function, and thus when the user got lost or when mountain accident happened, the tool has no sufficient functions to help the user to survive. Therefore, there remains a need for a new and improved design for an outdoor tool to overcome the problems presented above.

### SUMMARY OF THE INVENTION

The present invention provides an outdoor tool with multiple functions, which comprises a handle, a spring clip, a blade, a cover and a flint rod. The handle has a first end and a second end, an interior space formed inside of the handle is configured to secure the spring clip and to receive the blade. A pivot axle laterally penetrates the first end of the handle, and a lower portion of the blade is mounted on the pivot axle such that the blade is movable about the pivot axle to deploy out of the handle or to receive inside the interior space. Also, a connecting hole formed at the second end of the handle is configured to connect to the cover. A recessed portion formed at a lateral side of the handle is configured to receive the flint rod. The spring clip comprises a fixing segment and an actuating segment which are vertically parallel and configured to align or misalign with each other. A first end of the actuating segment has a mounting hole and a pulling piece respectively formed at a lower edge close to the fixing segment and protruding from an upper edge away from the fixing segment while a second end thereof is connected to the fixing segment. Moreover, the spring clip is disposed in the interior space and is secured inside the handle through the fixing segment. Through misaligning with the fixing segment, the actuating segment can be moved inside the handle. A mounting piece protrudes from the lower portion of the blade, and the blade is coupled with the spring clip when the blade is received in the interior space. The cover comprises an air intake, at least an air outlet, a connecting portion, a first sharpening stone and a second sharpening stone, and the air intake is communicated with the air outlet such that the outdoor tool with multiple functions of the present invention can be used as a whistle. Moreover, the connecting portion is configured to connect to the connecting hole of the handle such that the cover can be secured on the second end of the handle when not in use.

Comparing with conventional outdoor tool, the present invention is advantageous because: (i) in addition to cutting objects, the outdoor tool with multiple functions also can be used for whistling, starting a fire, opening a bottle, scraping fish scale, sharpening a knife thereby improving the practicability thereof; and (ii) after rotating out the blade, the mounting piece of the blade is mounted on the mounting hole of the spring clip, and when the blade is rotated back and received in the interior space, the actuating segment can tightly clamp the blade thereby improving the structural stableness.

### BRIEF DESCRIPTION OF THE DRAWINGS

FIG. 1 is a three-dimensional assembly view of an outdoor tool with multiple functions in the present invention.

FIG. 2 is a three-dimensional exploded view of the outdoor tool with multiple functions in the present invention.

FIG. 3 is a three-dimensional assembly view from another angle of the outdoor tool with multiple functions in the present invention.

FIG. 4 is a plane view illustrating a blade of the outdoor tool with multiple functions is in a deployed position in the present invention.

FIG. 5 is a sectional view illustrating the blade of the outdoor tool with multiple functions is in the deployed position in the present invention.

FIG. 6 is a three-dimensional view illustrating the blade of the outdoor tool with multiple functions is received in the handle in the present invention.

FIG. 7 is a plane view illustrating the blade of the outdoor tool with multiple functions is received in the handle in the present invention.

FIG. 8 is a sectional view illustrating the blade of the outdoor tool with multiple functions is received in the handle in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

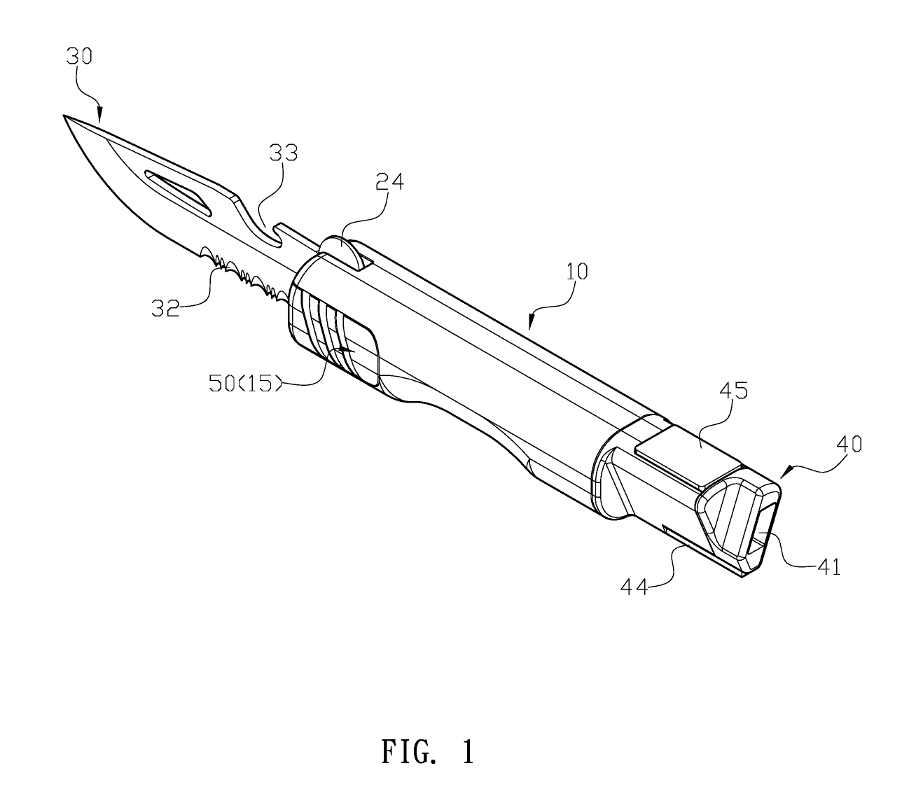

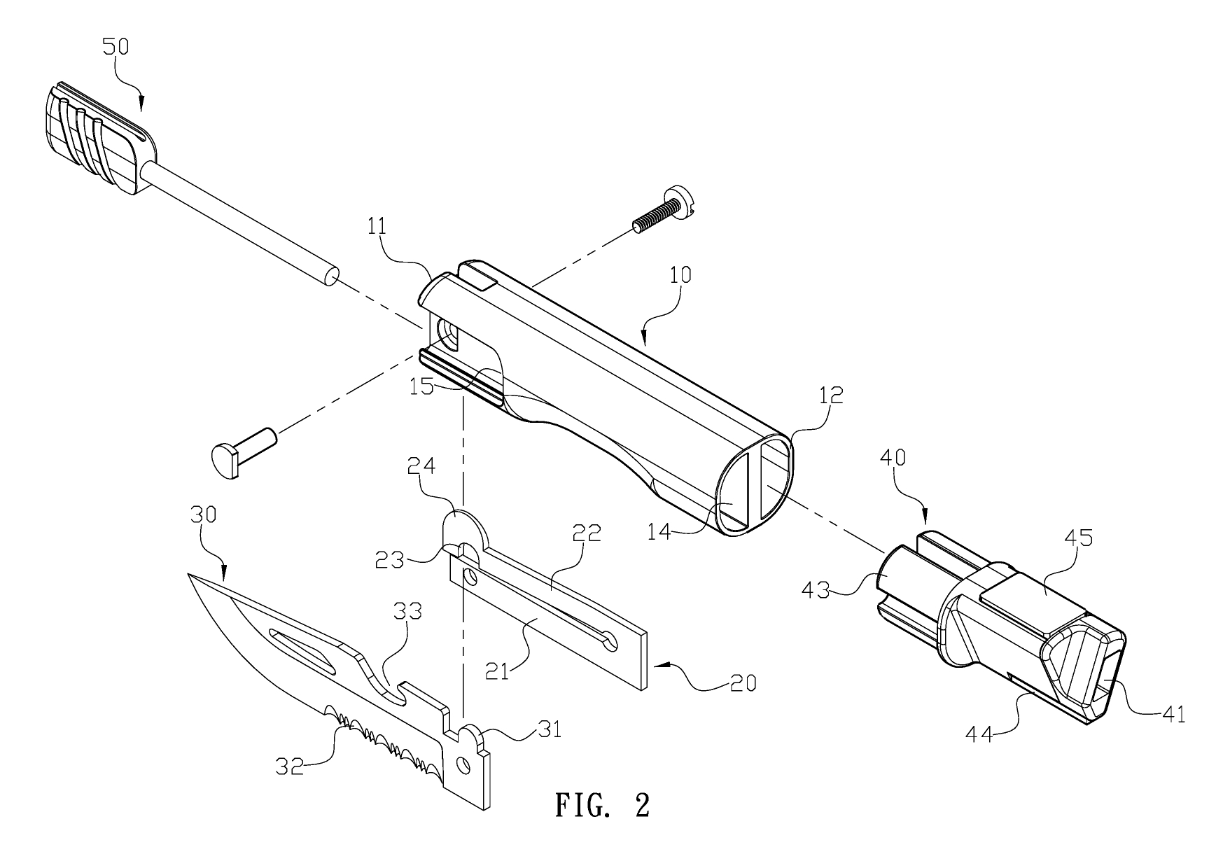

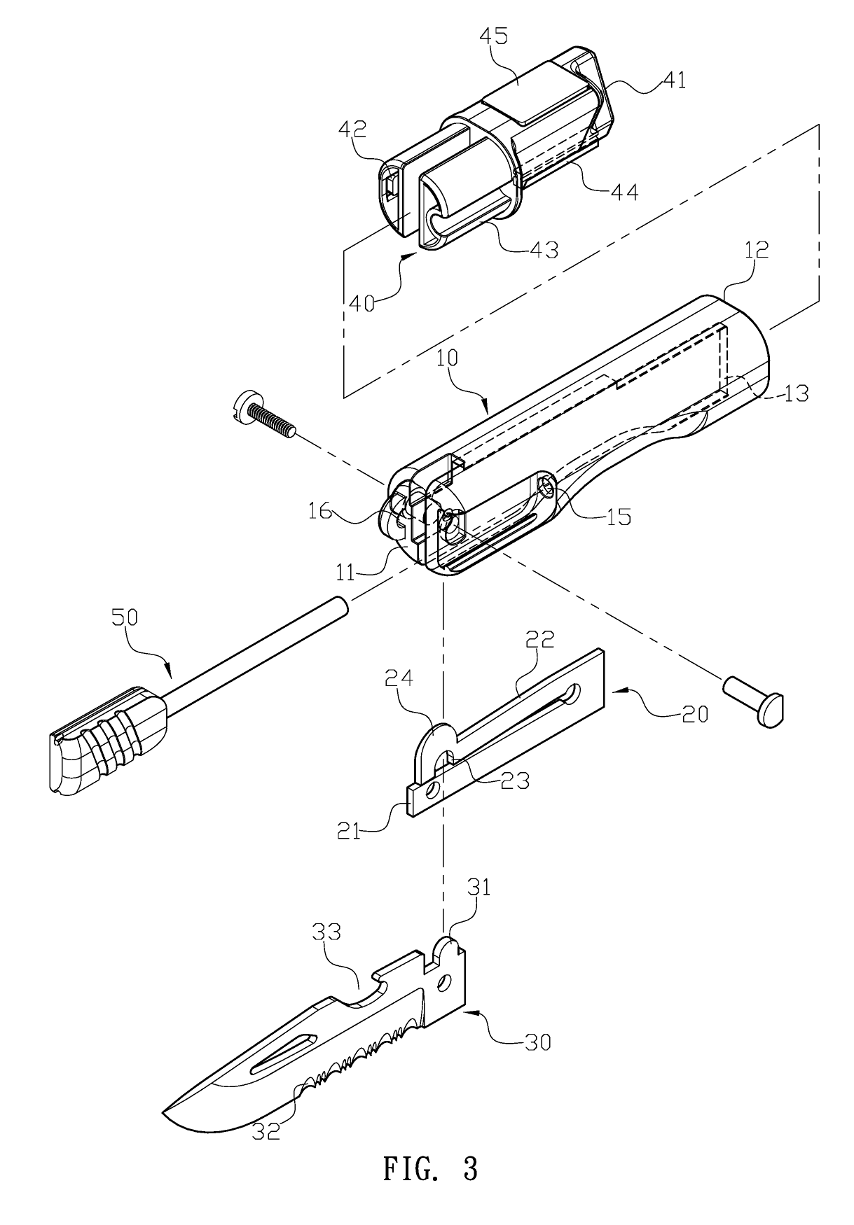

Referring to FIGS. 1 to 3, the present invention provides an outdoor tool with multiple functions, which comprises a handle (10), a spring clip (20), a blade (30), a cover (40) and a flint rod (50). The handle (10) has a first end (11) and a second end (12), an interior space (13) formed inside of the handle (10) is configured to secure the spring clip (20) and to receive the blade (30). A pivot axle laterally penetrates the first end (11) of the handle (10), and a lower portion of the blade (30) is mounted on the pivot axle such that the blade (30) is movable about the pivot axle to deploy out of the handle (10) or to receive inside the interior space (13). Also, a connecting hole (14) formed at the second end (12) of the handle (10) is configured to connect to the cover (40). A recessed portion (15) formed at a lateral side of the handle (10) is configured to receive the flint rod (50). The spring clip (20) comprises a fixing segment (21) and an actuating segment (22) which are vertically parallel and configured to align or misalign with each other. A first end of the actuating segment (22) has a mounting hole (23) and a pulling piece (24) respectively formed at a lower edge close to the fixing segment (21) and protruding from an upper edge away from the fixing segment (21) while a second end thereof is connected to the fixing segment (21). Moreover, the spring clip (20) is disposed in the interior space (13) and is secured inside the handle (10) through the fixing segment (21). Through misaligning with the fixing segment (21), the actuating segment (22) can be moved inside the handle (10). A mounting piece (31) protrudes from the lower portion of the blade (30), and the blade (30) is coupled with the spring clip (20) when the blade (30) is received in the interior space (13). The cover (40) comprises an air intake (41), at least an air outlet (42), a connecting portion (43), a first sharpening stone (44) and a second sharpening stone (45), and the air intake (41) is communicated with the air outlet (42) such that the outdoor tool of the present invention can be used as a whistle. Moreover, the connecting portion (43) is configured to connect to the connecting hole (14) of the handle (10) such that the cover (40) can be secured on the second end (12) of the handle (10) when not in use.

In one embodiment, the first end of the handle (10) has a though hole (16) which is configured to allow a rope or a cord to pass through it thereby allowing the outdoor tool with multiple functions of the present invention to be hanged on a body of a user or other places.

In another embodiment, an edge of the blade (30) has a zigzag segment (42) such that a user can use the blade (30) to scrape fish scale or to rub against the flint rod (50) to light a fire.

In still another embodiment, the blade (30) further has a notch (33) which can be used as a bottle opener.

In a further embodiment, the first sharpening stone (44) is made of Tungsten steel and is configured to sharpen the blade (30) or to rug against the flint rod (50) to light a fire.

In still a further embodiment, the second sharpening stone (45) is made of diamond sand blasting abrasives and is configured to sharpen the blade (30).

In yet a further embodiment, the flint rod (50) is a magnesium rod.

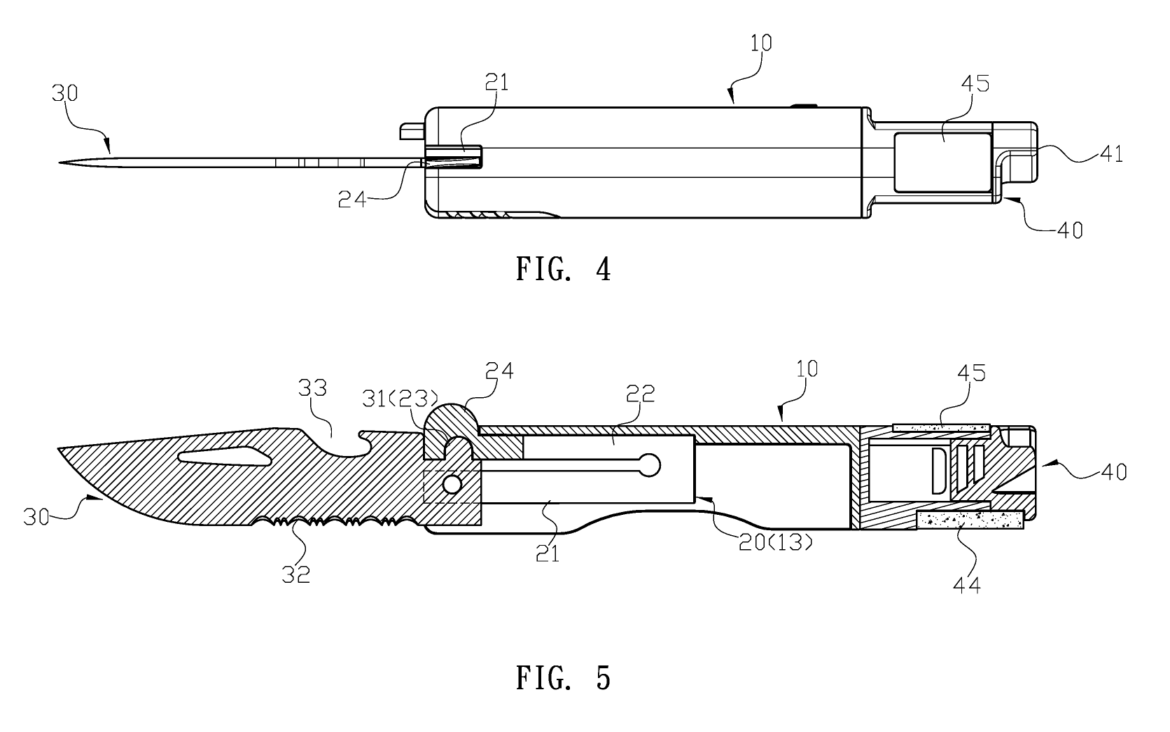

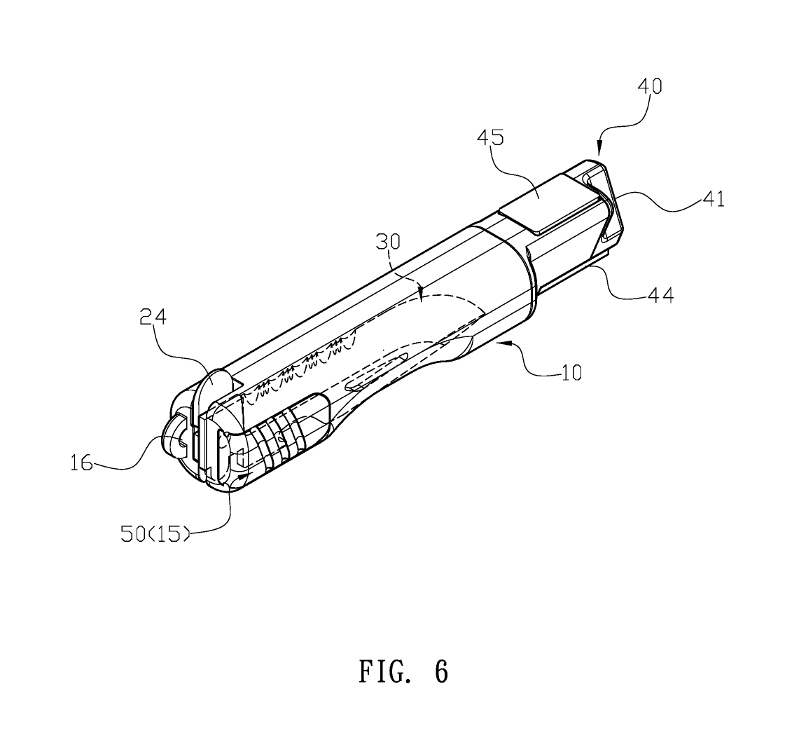

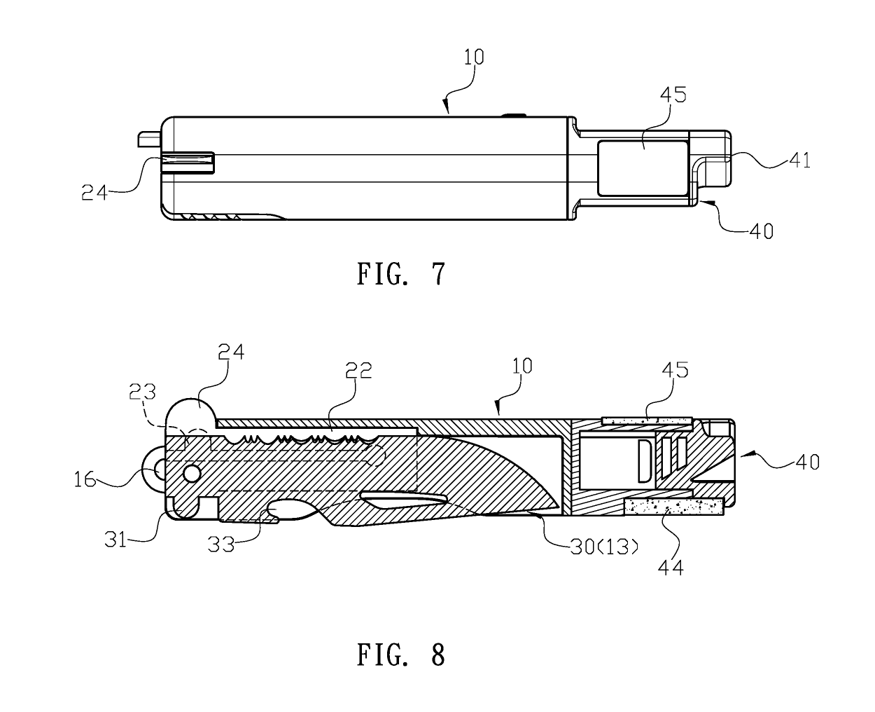

In actual application, the blade (30) received in the interior space (13) is rotated about the pivot axle on the first end (11) of the handle (10) to stick out of the handle (10), and since the resilience of the spring clip (20), the mounting hole (23) of the actuating segment (22) is mounted on the mounting piece (31) of the blade (30) (as shown in FIGS. 1, 4 and 5). A user can hold the handle (10) to use the blade (30) to remove branches or vines when climbing the mountain or to cut objects for preparing an outdoor picnic. Also, because of the communication between the air intake (41) and the air outlet (42), after detached from the handle (10), the cover (40) can be used as a whistle for assembling the crews or calling for help in emergency. In addition, the outdoor tool in the present invention is not only with function of cutting, but also with the functions of whistling, lighting a fire, opening a bottle, scraping fish scale, sharpening the blade (30), etc. which is more comprehensive and practical. Through pulling the pulling piece (24), the blade (30) is allowed to rotate about the pivot axle and back into the interior space (13) of the handle (10) and is firmly clamped by the actuating segment (22) of the spring clip (20) (as shown in FIGS. 6 to 8).

Furthermore, the first sharpening stone (44) and the second sharpening stone (45) can also be used to sharpen a variety of knives in daily life. In addition, the pulling piece (24) protruding from the handle (10) can be used as a flat head screw driver.

Comparing with conventional outdoor tool, the present invention is advantageous because: (i) in addition to cutting, the outdoor tool with multiple functions also can be used for whistling, starting a fire, opening a bottle, scraping fish scale, sharpening a knife thereby improving the practicability thereof; and (ii) after rotating out the blade (30), the mounting piece (31) of the blade (30) is mounted on the mounting hole (23) of the spring clip (20), and when the blade (30) is rotated back and received in the interior space (13), the actuating segment (22) can tightly clamp the blade (30) thereby improving the structural stableness.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An outdoor tool with multiple functions comprising:
a handle having a first end and a second end, and an interior space, which is formed inside the handle, configured to secure a spring chip and to receive a blade, a pivot axle laterally penetrating the first end of the handle, and a lower portion of the blade mounted on the pivot axle such that the blade configured to be rotated about the pivot axle to deploy out of the handle or to receive inside the interior space, the second end of the handle having a connecting hole, and a recessed portion, which is formed at a lateral side of the handle, configured to receive a flint rod;
the spring clip comprising a fixing segment and an actuating segment which are vertically parallel and configured to align or misalign with each other, the spring clip disposed in the interior space and secured inside the handle through the fixing segment, with the resilience of the spring clip, the actuating segment configured to be moved to misalign with the fixing segment, and a first end of the actuating segment having a mounting hole and a pulling piece respectively formed at a lower edge of the actuating segment close to the fixing segment and protruding from an upper edge thereof away from the fixing segment while a second end of the actuating segment connected to the fixing segment;
the blade comprising a mounting piece protruding from the lower portion thereof, and the blade coupled with the spring clip when received in the interior space; and
a cover having an air intake, at least an air outlet, a connecting portion, a first sharpening stone and a second sharpening stone, and the air intake communicated with the air outlet such that the cover configured to be used as a whistle, the connecting portion configured to connect to the connecting hole of the handle such that the cover configured to be secured on the second end of the handle when not in use.

2. The outdoor tool with multiple functions of claim 1, wherein the first end of the handle has a through hole which is configured to be passed through by a rope or a cord.

3. The outdoor tool with multiple functions of claim 1, wherein an edge of the blade comprises a zigzag segment.

4. The outdoor tool with multiple functions of claim 1, wherein the blade has a notch.

5. The outdoor tool with multiple functions of claim 1, wherein the first sharpening stone is made of Tungsten steel.

6. The outdoor tool with multiple functions of claim 1, wherein the second sharpening stone is made of diamond sand blasting abrasives.

7. The outdoor tool with multiple functions of claim 1, wherein the flint rod is a magnesium rod.
